(19) United States
(12) Patent Application Publication
(10) Pub. No.: US 2026/0084969 A1
(43) Pub. Date: Mar. 26, 2026

(54) PRODUCTION OF SPHERICAL GRAPHITE POWDER

(71) Applicant: ENTEGRIS, INC., Billerica, MA (US)

(72) Inventors: Juan R. Inga, Fort Worth, TX (US); Todd W. Bendure, Denton, TX (US); Troy Scoggins, Decatur, TX (US); Amelia H. C. Hart, Fort Worth, TX (US)

(21) Appl. No.: 19/337,792

(22) Filed: Sep. 23, 2025

Related U.S. Application Data
(60) Provisional application No. 63/698,010, filed on Sep. 23, 2024.

(51) Int. Cl. C01B 32/205; B01J 8/24

(52) U.S. Cl. CPC C01B 32/205; B01J 8/24; B01J 2208/00415; B01J 2208/00442; B01J 2208/00752; B01J 2208/00769; C01P 2002/70; C01P 2004/32

(57) ABSTRACT

Methods and systems for producing spherical graphite particles is disclosed. The method comprises feeding a slurry to a spray dryer. The slurry comprises a plurality of first particles and a petroleum pitch. The slurry is dispensed from a nozzle of the spray dryer to produce a second plurality of particles. The sphericity of the second plurality of particles is different from a sphericity of the first plurality of particles. The second plurality of particles is fed from the spray dryer to a vertical graphitization column, where the second plurality of particles are heated to produce a third plurality of particles. The sphericity of the third plurality of particles is different from the sphericity of the first plurality of particles. The third plurality of particles can be a plurality of spherical graphite particles.

### FIELD

The present disclosure relates to a method and a system for producing spherical graphite powder.

### BACKGROUND

Currently, spherical graphite comes from natural graphite (flakes) that are made spherical via attrition. However, the loss rate during the process is greater than 50%.

### SUMMARY

Some embodiments relate to a method. In some embodiments, the method comprises feeding, to a spray dryer, a slurry. In some embodiments, the slurry comprises a first plurality of particles and a petroleum pitch. In some embodiments, at least the slurry is dispensed from a nozzle of the spray dryer to produce a second plurality of particles. In some embodiments, the sphericity of the second plurality of particles is different from a sphericity of the first plurality of particles. In some embodiments, the method comprises feeding at least the second plurality of particles from the spray dryer to a vertical graphitization column. In some embodiments, at least the second plurality of particles in the vertical graphitization column are heated to produce a third plurality of particles. In some embodiments, the sphericity of the third plurality of particles is different from the sphericity of the first plurality of particles. In some embodiments, the third plurality of particles comprises a plurality of graphite particles.

Some embodiments relate to a system. In some embodiments, the system comprises a spray dryer, a vertical graphitization column, and at least one heater. In some embodiments, when a slurry comprising a first plurality of particles and a petroleum pitch is dispensed from a nozzle of the spray dryer, the spray dryer produces a second plurality of particles. In some embodiments, the sphericity of the second plurality of particles is different from a sphericity of the first plurality of particles. In some embodiments, the vertical graphitization column is configured to receive the second plurality of particles from the spray dryer. In some embodiments, when the second plurality of particles are heated in the vertical graphitization column, the vertical graphitization column produces a third plurality of particles. In some embodiments, the sphericity of the third plurality of particles is different from the sphericity of the first plurality of particles. In some embodiments, the at least one heater is configured to heat at least the spray dryer and the vertical graphitization column.

In a preferred embodiment, the apparatus comprises a vertically oriented column chamber equipped with an inlet for receiving carbon particles, a heating system for thermally treating the particles within the chamber, and an outlet for discharging the graphitized product. The column chamber further includes a first sensor positioned approximately midway along the heated zone and a second sensor located near the outlet. Each sensor is configured to extract a sample of particles via a pressure differential and direct the sample through an X-ray diffractometer (XRD), which measures the degree of graphitization.

A control unit is operatively coupled to the sensors and the outlet and is configured to regulate the discharge rate of particles from the column chamber. By adjusting the residence time of the particles within the heated zone, the control unit modulates the degree of graphitization, thereby enhancing the uniformity and quality of the resulting graphitized material.

### BRIEF DESCRIPTION OF THE DRAWINGS

FIG. 1 is a flowchart of a method for producing spherical graphite powder, according to some embodiments.

FIG. 2 is a schematic diagram of a system, according to some embodiments.

FIG. 3 is a schematic diagram of a system, according to some embodiments.

### DETAILED DESCRIPTION

Some embodiments relate to a method for producing spherical particles.

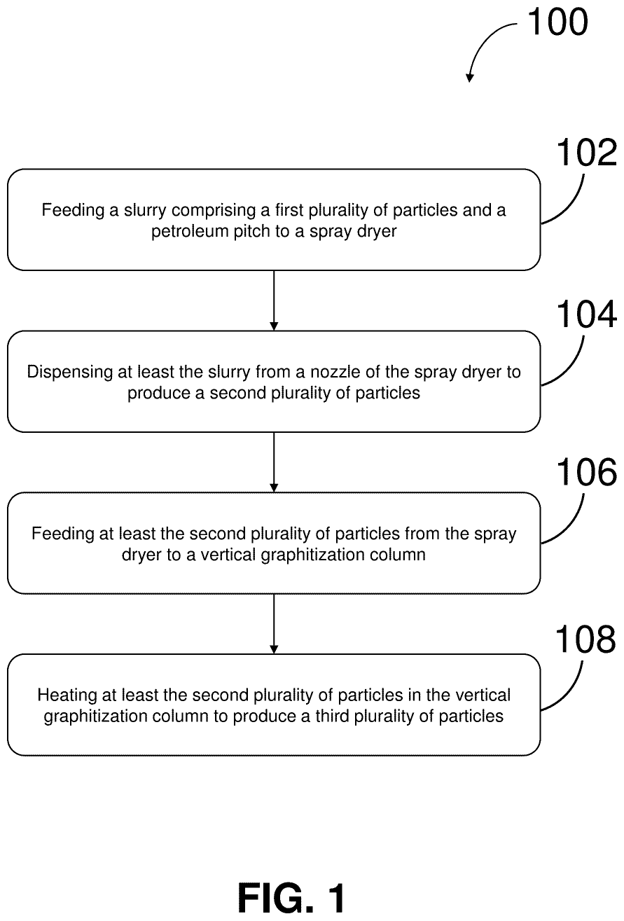

FIG. 1 is a flowchart of the method 100 for producing spherical particles, according to some embodiments.

At step 102, in some embodiments, the method comprises feeding a slurry comprising a first plurality of particles and a petroleum pitch to a spray dryer. In some embodiments, the slurry can be fed to the spray dryer by gravitational forces, pumping, or gas pressure.

In some embodiments, the first plurality of particles comprises a plurality of petroleum coke particles. Petroleum pitch is a residue from heat treatment and distillation of petroleum fractions. It is a solid at room temperature, consists of a complex mixture of numerous predominantly aromatic and alkyl-substituted aromatic hydrocarbons, and exhibits a broad softening point range.

In some embodiments, the sphericity of the first plurality of particles is 0.1 to 0.9, or any range or subrange between 0.1 to 0.9. In some embodiments, the sphericity of the first plurality of particles can be 0.1 to 0.8, 0.1 to 0.7, 0.1 to 0.6, 0.1 to 0.5, 0.1 to 0.4, 0.1 to 0.3, 0.1 to 0.2, 0.2 to 0.9, 0.3 to 0.9, 0.4 to 0.9, 0.5 to 0.9, 0.6 to 0.9, 0.7 to 0.9, or 0.8 to 0.9.

In some embodiments, the slurry comprises a metal salt. In some embodiments, the metal salt comprises at least one of a metal carbonate, a metal nitrate, a metal halide, or any combination thereof. In some embodiments, the metal halide can be a metal fluoride, a metal chloride, a metal bromide, or a metal iodide. Examples of the metal in the metal salt include, but not limited thereto, sodium, calcium, potassium, magnesium, lead, titanium, manganese, nickel, tin, vanadium, iron, copper, cobalt, zinc, yttrium, zirconium, molybdenum, and silicon.

In some embodiments, the slurry comprises a metal oxide. Examples of the metal in the metal oxide include, but not limited thereto, sodium, calcium, potassium, magnesium, lead, titanium, manganese, nickel, tin, vanadium, iron, copper, cobalt, zinc, yttrium, zirconium, molybdenum, and silicon. In some embodiments, the slurry comprises a silicon oxide.

At step 104, in some embodiments, the method comprises dispensing at least the slurry from a nozzle of the spray dryer to produce a second plurality of particles.

In some embodiments, the sphericity of the second plurality of particles is different from the sphericity of the first plurality of particles.

In some embodiments, the sphericity of the first plurality of particles is less than the sphericity of the second plurality of particles.

The dispensing can be conducted at a temperature of 200° C. to 750° C., or any range or subrange between 200° C. to 750° C. In some embodiments, the dispensing can be conducted at a temperature of 200° C. to 700° C., 200° C. to 650° C., 200° C. to 600° C., 200° C. to 550° C., 200° C. to 500°C., 200° C. to 450° C., 200° C. to 400° C., 200° C. to 350° C., 200° C. to 300° C., 300° C. to 750° C., 350° C. to 750° C., 400° C. to 750° C., 450° C. to 750° C., 500° C. to 750° C., 550° C. to 750° C., 600° C. to 750° C., 650°C. to 750° C., or 700° C. to 750° C.

At step 106, in some embodiments, the method comprises feeding at least the second plurality of particles from the spray dryer to a vertical graphitization column. In some embodiments, feeding the second plurality of particles from the spray dryer to the vertical graphitization column occurs through gravitational forces, by pumping the particles, or by gas pressure.

At step 108, in some embodiments, the method comprises heating at least the second plurality of particles in the vertical graphitization column to produce a third plurality of particles.

The heating in the vertical graphitization column can be conducted at a temperature of 2000°C. to 3300° C., or any range of subrange between 2000° C. to 3300° C. In some embodiments, the heating in the vertical graphitization column can be conducted at a temperature of 2000° C. to 3200° C., 2000° C. to 3100° C., 2000° C. to 3000° C., 2000° C. to 2900° C., 2000° C. to 2800° C., 2000° C. to 2700° C., 2000° C. to 2600° C., 2000° C. to 2500° C., 2000° C. to 2400° C., 2000° C. to 2300° C., 2000° C., 2200° C., 2000° C. to 2100° C., 2100° C. to 3300° C., 2200° C. to 3300° C., 2300° C. to 3300° C., 2400° C. to 3300° C., 2500° C. to 3300° C., 2600° C. to 3300° C., 2700° C. to 3300° C., 2800° C. to 3300° C., 2900° C. to 3300° C., 3000° C. to 3300° C., 3100° C. to 3300° C., or 3200° C. to 3300° C.

In some embodiments, the heating is conducted at atmospheric pressure.

In some embodiments, the heating is conducted in a presence of a fluidizing gas. In some embodiments, the fluidizing gas comprises at least one of a dinitrogen gas, a nitrogen gas, a methane gas, an ethane gas, a hydrogen gas, a silicon dioxide gas, a helium gas, an argon gas, or any combination thereof.

In some embodiments, the sphericity of the third plurality of particles is different from the sphericity of the first plurality of particles. In some embodiments, the sphericity of the first plurality of particles is less than the sphericity of the third plurality of particles. In some embodiments the third plurality of particles comprises a plurality of spherical graphite particles.

In some embodiments, the method is a continuous process.

Some embodiments relate to a system. In some embodiments, the system comprises a spray dryer. In some embodiments, the spray dryer comprises a nozzle. In some embodiments, the spray dryer comprises multiple nozzles. In some embodiments, when a slurry comprising a first plurality of particles and a petroleum pitch is dispensed from a nozzle of the spray dryer, the spray dryer produces a second plurality of particles. In some embodiments, the sphericity of the second plurality of particles is different from the sphericity of the first plurality of particles. In some embodiments, the sphericity of the first plurality of particles is less than the sphericity of the second plurality of particles.

In some embodiments, the system comprises a vertical graphitization column. In some embodiments, the vertical graphitization column is configured to receive the second plurality of particles from the spray dryer. In some embodiments, when the second plurality of particles are heated in the vertical graphitization column, the vertical graphitization column produces a third plurality of particles. In some embodiments, the third plurality of particles comprise a plurality of spherical graphite particles. In some embodiments, the sphericity of the third plurality of particles is different from the sphericity of the first plurality of particles. In some embodiments, the sphericity of the first plurality of particles is less than the sphericity of the third plurality of particles.

In some embodiments, the system comprises at least one heater. In some embodiments, the at least one heater is configured to heat at least the spray dryer and the vertical graphitization column. In some embodiments, the at least one heater comprises an induction heater, a microwave heater, an infrared heater, a radiative heater, a conductive heater, a convective heater, an electrical resistance heater, or any combination thereof. In some embodiments, the at least one heater comprises at least one induction heater. In some embodiments, the at least one heater comprises at least one microwave heater.

In some embodiments, the at least one heater is configured to heat the spray dryer to a temperature of 200° C. to 700° C., or any range or subrange between 200° C. to 700° C. In some embodiments, the at least one heater is configured to heat the spray dryer to a temperature of 200° C. to 700° C., 200° C. to 650° C., 200° C. to 600° C., 200° C. to 550° C., 200° C. to 500° C., 200° C. to 450° C., 200°C. to 400° C., 200° C. to 350° C., 200° C. to 300° C., 300° C. to 750° C., 350° C. to 750° C., 400° C. to 750° C., 450° C. to 750° C., 500° C. to 750° C., 550° C. to 750° C., 600° C. to 750° C., 650° C. to 750° C., or 700° C. to 750° C.

In some embodiments, at least one heater is configured to heat the vertical graphitization column to a temperature of 2000° C. to 3300° C., or any range or subrange between 2000° C. to 3300° C. In some embodiments, the at least one heater is configured to heat the vertical graphitization column to a temperature of 2000° C. to 3200° C., 2000° C. to 3100° C., 2000° C. to 3000° C., 2000° C. to 2900° C., 2000°C. to 2800° C., 2000° C. to 2700° C., 2000° C. to 2600° C., 2000° C. to 2500° C., 2000° C. to 2400° C., 2000°C. to 2300° C., 2000° C., 2200° C., 2000° C. to 2100° C., 2100° C. to 3300° C., 2200° C. to 3300° C., 2300° C. to 3300° C., 2400° C. to 3300° C., 2500° C. to 3300° C., 2600° C. to 3300° C., 2700° C. to 3300° C., 2800° C. to 3300° C., 2900° C. to 3300° C., 3000° C. to 3300° C., 3100° C. to 3300° C., or 3200° C. to 3300° C.

In some embodiments, the system comprises a fluidizing gas source for supplying fluidizing gas to the vertical graphitization column. In some embodiments, the fluidizing gas comprises at least one of a dinitrogen gas, a nitrogen gas, a methane gas, an ethane gas, a hydrogen gas, a silicon dioxide gas, a helium gas, an argon gas, or any combination thereof.

The disclosed vertical graphitization column provides enhanced operational efficiency and cost-effectiveness in the thermal conversion of carbon particles to graphitized material. Through the implementation of a dual-sensor configuration integrated with X-ray diffractometry, the system enables real-time monitoring and control of the graphitization percentage at multiple points within the column. A control unit, operatively coupled to the sensors and the discharge outlet, dynamically adjusts the particle residence time within the heated zone by regulating the discharge rate. This precise control mechanism ensures consistent product quality, optimizes throughput, and reduces energy consumption, thereby improving overall process speed and reducing operational costs.

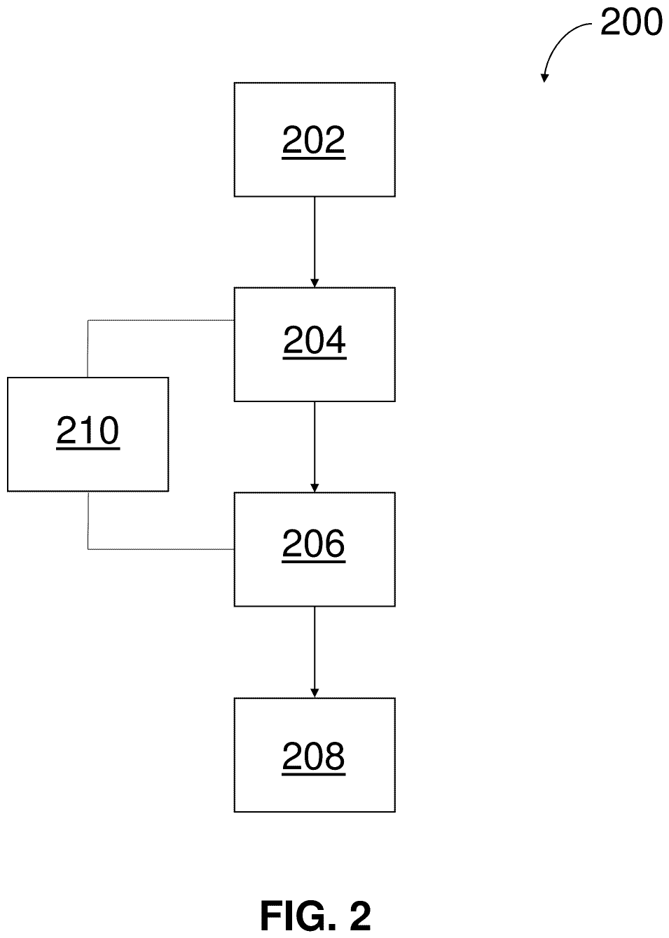

FIG. 2 is a schematic diagram of a system 200, according to some embodiments. The system 200 comprises a spray dryer 204. A slurry 202 comprising a first plurality of particles and a petroleum pitch, is fed to the spray dryer 204. The spray dryer 204 produces a second plurality of particles, which are then fed to a vertical graphitization column 206. The vertical graphitization column produces a third plurality of particles 208. The system 200 comprises at least one heater 210. The at least one heater 210 is configured to heat at least the spray dryer 204 and the vertical graphitization column 206.

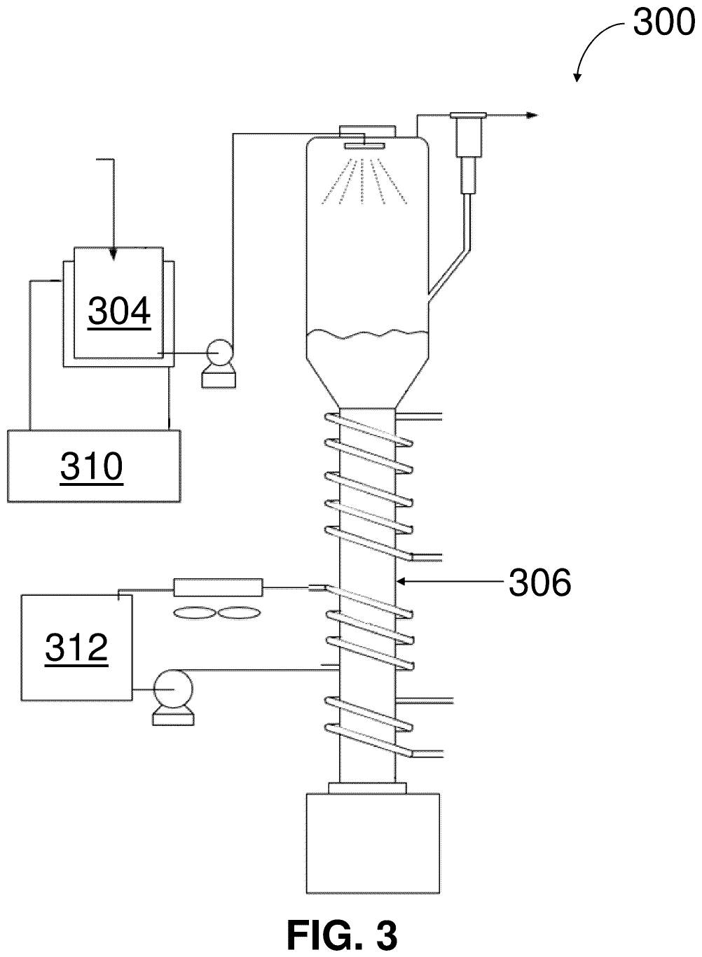

FIG. 3 is a schematic diagram of a system 300, according to some embodiments. The system comprises a spray dryer 304, in which a slurry comprising a first plurality of particles and a petroleum pitch is fed. The spray dryer is heated by heater 310. The spray dryer 304 produces a second plurality of particles, which are then fed to a vertical graphitization column 306. The vertical graphitization column is heated by heater 312. The vertical graphitization column 306 produces a third plurality of particles.

Any one or more of the embodiments disclosed herein shall be understood to be combinable without departing from the scope or spirit of the disclosure.

### EXAMPLE 1

A slurry comprising petroleum pitch and a plurality of 1 micron sized coke particles is fed to a spray dryer. The spray dryer is heated to about 300° C. using a hot oil system. The slurry is dispensed from the spray dryer at about 400° C. to produce a second plurality of particles. The second plurality of particles are 30 micron spheres which are heated to about 450° C. by a fluidizing gas so that the particles do not agglomerate. The second plurality of particles are then fed to the vertical graphitization column and heated to about 2500-3300° C. via induction heating to produce spherical graphite particles. The sphericity of the spherical graphite particles is greater than the sphericity of the plurality of coke particles.

### Aspects

Various Aspects are described below. It is to be understood that any one or more of the features recited in the following Aspect(s) can be combined with any one or more other Aspect(s).
Aspect 1. A method comprising:
   feeding, to a spray dryer, a slurry comprising a first plurality of particles and a petroleum pitch;
   dispensing at least the slurry from a nozzle of the spray dryer to produce a second plurality of particles,
      wherein a sphericity of the second plurality of particles is different from a sphericity of the first plurality of particles;
   feeding at least the second plurality of particles from the spray dryer to a vertical graphitization column; and
   heating at least the second plurality of particles in the vertical graphitization column to produce a third plurality of particles,
      wherein a sphericity of the third plurality of particles is different from the sphericity of the first plurality of particles.
Aspect 2. The method according to Aspect 1, wherein the slurry further comprises:
   a metal salt,
      wherein the metal salt comprises at least one of a metal carbonate, a metal nitrate, a metal chloride, or any combination thereof.
Aspect 3. The method according to any one of Aspects 1-2, wherein the first plurality of particles comprises a plurality of petroleum coke particles.
Aspect 4. The method according to any one of Aspects 1-3, wherein the dispensing is conducted at a temperature of 200° C. to 750° C.
Aspect 5. The method according to any one of Aspects 1-4, wherein the sphericity of the first plurality of particles is less than the sphericity of the second plurality of particles.
Aspect 6. The method according to any one of Aspects 1-5, wherein the sphericity of the first plurality of particles is less than the sphericity of the third plurality of particles.
Aspect 7. The method according to any one of Aspects 1-6, wherein the sphericity of the first plurality of particles is 0.1 to 0.9.
Aspect 8. The method according to any one of Aspects 1-7, wherein the heating is conducted at a temperature of 2000° C. to 3300° C.
Aspect 9. The method according to any one of Aspects 1-8, wherein the heating is conducted at atmospheric pressure.
Aspect 10. The method according to any one of Aspects 1-9, wherein the heating is conducted in a presence of a fluidizing gas, wherein the fluidizing gas comprises at least one of a dinitrogen gas, a methane gas, an ethane gas, a hydrogen gas, a silicon dioxide gas, a nitrogen gas, an argon gas, or any combination thereof.
Aspect 11. The method according to any one of Aspects 1-10, wherein the third plurality of particles comprises a plurality of spherical graphite particles.
Aspect 12. The method according to any one of Aspects 1-11, wherein the method is a continuous process.
Aspect 13. A system comprising:
   a spray dryer,
      wherein, when a slurry comprising a first plurality of particles and a petroleum pitch is dispensed from a nozzle of the spray dryer, the spray dryer produces a second plurality of particles;
         wherein a sphericity of the second plurality of particles is different from a sphericity of the first plurality of particles;
   a vertical graphitization column,
      wherein the vertical graphitization column is configured to receive the second plurality of particles from the spray dryer;
      wherein, when the second plurality of particles are heated in the vertical graphitization column, the vertical graphitization column produces a third plurality of particles;
         wherein a sphericity of the third plurality of particles is different from the sphericity of the first plurality of particles; and
   at least one heater,
      wherein the at least one heater is configured to heat at least the spray dryer and the vertical graphitization column.
Aspect 14. The system according to Aspect 13, further comprising a fluidizing gas source for supplying a fluidizing gas to the vertical graphitization column.
Aspect 15. The system according to any one of Aspects 13-14, wherein the fluidizing gas comprises at least one of a dinitrogen gas, a methane gas, an ethane gas, a hydrogen gas, a silicon dioxide gas, a nitrogen gas, an argon gas, or any combination thereof.
Aspect 16. The system according to any one of Aspects 13-15, wherein the at least one heater comprises at least one induction heater.
Aspect 17. The system according to any one of Aspects 13-16, wherein the at least one heater comprises at least one microwave heater.
Aspect 18. The system according to any one of Aspects 13-17, wherein the at least one heater is configured to heat the spray dryer to a temperature of 250° C. to 750° C.
Aspect 19. The system according to any one of Aspects 13-18, wherein the at least one heater is configured to heat the vertical graphitization column to a temperature of 2000° C. to 3300° C.
Aspect 20. The system according to any one of Aspects 13-19, wherein the third plurality of particles comprises a plurality of spherical graphite particles.

What is claimed is:

1. A method comprising:
feeding, to a spray dryer, a slurry comprising a first plurality of particles and a petroleum pitch;
dispensing at least the slurry from a nozzle of the spray dryer to produce a second plurality of particles,
wherein a sphericity of the second plurality of particles is different from a sphericity of the first plurality of particles;
feeding at least the second plurality of particles from the spray dryer to a vertical graphitization column; and
heating at least the second plurality of particles in the vertical graphitization column to produce a third plurality of particles,
wherein a sphericity of the third plurality of particles is different from the sphericity of the first plurality of particles.

2. The method of claim 1, wherein the slurry further comprises:
a metal salt,
wherein the metal salt comprises at least one of a metal carbonate, a metal nitrate, a metal chloride, or any combination thereof.

3. The method of claim 1, wherein the first plurality of particles comprises a plurality of petroleum coke particles.

4. The method of claim 1, wherein the dispensing is conducted at a temperature of 200 °C. to 750 °C.

5. The method of claim 1, wherein the sphericity of the first plurality of particles is less than the sphericity of the second plurality of particles.

6. The method of claim 1, wherein the sphericity of the first plurality of particles is 0.1 to 0.9.

7. The method of claim 1, wherein the heating is conducted at a temperature of 2000° C. to 3300 °C.

8. The method of claim 1, wherein the slurry is fed to the spray dryer by at least one of gravitational force, pumping, or gas pressure.

9. A system comprising:
a spray dryer,
wherein, when a slurry comprising a first plurality of particles and a petroleum pitch is dispensed from a nozzle of the spray dryer, the spray dryer produces a second plurality of particles;
wherein a sphericity of the second plurality of particles is different from a sphericity of the first plurality of particles;
a vertical graphitization column,
wherein the vertical graphitization column is configured to receive the second plurality of particles from the spray dryer;
wherein, when the second plurality of particles are heated in the vertical graphitization column, the vertical graphitization column produces a third plurality of particles;
wherein a sphericity of the third plurality of particles is different from the sphericity of the first plurality of particles; and
at least one heater,
wherein the at least one heater is configured to heat at least the spray dryer and the vertical graphitization column.

10. The system of claim 9, further comprising a fluidizing gas source for supplying a fluidizing gas to the vertical graphitization column.

11. The system of claim 9, wherein the fluidizing gas comprises at least one of a dinitrogen gas, a methane gas, an ethane gas, a hydrogen gas, a silicon dioxide gas, a nitrogen gas, an argon gas, or any combination thereof.

12. The system of claim 9, wherein the at least one heater comprises at least one induction heater.

13. The system of claim 9, wherein the at least one heater comprises at least one microwave heater.

14. The system of claim 9, wherein the at least one heater is configured to heat the spray dryer to a temperature of 250 °C. to 750° C.

15. A vertical graphitization column for graphitizing carbon particles, the column comprising:
a column chamber;
an inlet configured to receive the carbon particles into the column chamber;
a heating system configured to heat the carbon particles within the column chamber; and
an outlet configured to discharge the graphitized particles from the column chamber;
a first sensor positioned within the column chamber at an intermediate location along the heated zone;
a second sensor positioned proximate to the outlet of the column chamber;
each sensor comprising a sampling mechanism configured to extract particles via a pressure differential and direct the particles through an X-ray diffractometer (XRD) to measure a graphitization percentage; and
a control unit operatively coupled to the sensors and the outlet, the control unit being configured to regulate the discharge rate of particles from the column chamber based on the measured graphitization percentage, thereby adjusting the residence time of the particles within the heated zone to optimize product uniformity and throughput.

16. The vertical graphitization column of claim 15, wherein each sensor comprises a sampling mechanism configured to extract particles via a pressure differential and to either:
percentage; or

17. The vertical graphitization column according to claim 15, wherein the control unit is further configured to adjust an operational parameter of the heating system based on the measured physical property to control the rate of graphitization.

18. The vertical graphitization column according to claim 15, further comprises a first sensor positioned midway along a heated zone and a second sensor positioned near an outlet.

19. The vertical graphitization column according to claim 18, wherein each sensor is configured to extract a sample of particles via a pressure differential and direct the sample through an X-ray diffractometer to measure a graphitization percentage.

20. The vertical graphitization column according to claim 19, further comprising a control unit operatively coupled to the sensors and the outlet, the control unit being configured to regulate the discharge rate of particles based on the measured graphitization percentage.
